(19) United States
(12) Patent Application Publication
(10) Pub. No.: US 2013/0010647 A1
(43) Pub. Date: Jan. 10, 2013

(54) Audio Network System and Display Method

(75) Inventors: Ayumi Fukata, Hamamatsu-shi (JP); Kei Nakayama, Hamamatsu-shi (JP)

(73) Assignee: Yamaha Corporation, Shizuoka-Ken (JP)

(21) Appl. No.: 13/636,854

(22) PCT Filed: Mar. 24, 2011
(86) PCT No.: PCT/JP2011/057167

§ 371 Date: Sep. 24, 2012

(30) Foreign Application Priority Data
Mar. 24, 2010 (JP) 2010-068940
Mar. 23, 2011 (JP) 2011-064709

(51) Int. Cl. H04L 12/42

(52) U.S. Cl. 370/255

(57) ABSTRACT

In a top row on an audio network view screen, device images corresponding to devices composing a basic network are displayed in such a manner as to be arranged in a horizontal direction according to a connection order along with connection cable images indicative of connections between the device images according to connections between devices in the network. In display rows subsequent under the top row, other device images corresponding to devices composing another network which is connected to a connection node in the basic network with a full bridge are displayed in such a manner as to be arranged in the horizontal direction in a connection order along with connection cable images indicative of connections between the device images according to connections in the other network. As for a network connected to the basic network with a partial bridge setting, a partial bridge image is displayed in a display rows.

### TECHNICAL FIELD

The present invention relates to an audio network system comprising plural networks and more specifically to a technique for displaying a connection manner of devices composing the networks.

### BACKGROUND

Conventionally, an audio network that transmits audio signals among a plurality of nodes is known. As examples of such an audio network, CobraNet (trademark) and EtherSound (trademark) as disclosed in Non-Patent Literatures 1 and 2 described below are known.

For example, Patent Literature 1 described below discloses, as a connection manner of the plurality of nodes composing the audio network, a cascade connection manner in which the nodes are connected in a form of one line having both ends and a ring connection manner in which the both ends of the cascade line are connected with each other to form a loop. The audio network disclosed in Patent Literature 1 can transmit and receive the audio signals among the nodes by circulating a transmission frame containing the audio signals of a plurality of channels through a transmission path which is formed among the nodes connected in the cascade or ring connection manner. Control of sample timing required to transmit and receive the audio signals in the network is disclosed in Patent Literature 2 described below, for example. In the audio network connected in a ring, network reliability can be improved by performing redundancy operation (see Patent Literature 3 described below).

### PRIOR ART LITERATURES

### Patent Literatures

### [Patent Literature 1]

Japanese Patent Application Laid-open Publication No. 2009-094589

### [Patent Literature 2]

Japanese Patent Application Laid-open Publication No. 2008-072347

### [Patent Literature 3]

Japanese Patent Application Laid-open Publication No. 2007-259347

### Non-Patent Literatures

### [Non-Patent Literature 1]

“CobraNet™”, [online], BALCOM Co., Ltd., [Searched on Mar. 7, 2010], Internet <URL: http://www.balcom.co.jp/cobranet.htm>

### [Non-Patent Literature 2]

Carl Conrad, “EtherSound™ in a studio environment”, [online], Digigram S. A., [Searched on Mar. 7, 2010], Internet <URL: http://www.ethersound.com/news/getnews.php?enews_key=101>

In a conventional network system comprising one or more networks, a configuration of a plurality of devices which are physically and electrically connected with each other directly corresponds to a configuration of the network system. That is to say, in the conventional network system, as long as the devices are physically and electrically connected with each other to be in a communicable state, the audio signal can be transmitted between the devices.

Here, as a scale of the audio network system becomes large, it is required that the transmission of the audio signal can be continued even if cable disconnection or the like occurs (fault tolerance) or that a plurality of systems each constructed independently from other systems are interconnected to form one audio network system (expandability). In the conventional audio network system, since a device detection procedure or user interface operates assuming that the physical and electrical connection is equivalent to a transmission pass of the audio signal, the fault tolerance and the expandability are not fully considered.

On the other hand, in an audio network system capable of securing the fault tolerance and the expandability, it is conceivable that a physical and electrical connection status is different from an actual operation status (i.e., a transmission range of the audio signal) in response to current settings and/or operation statuses of the devices physically and electrically connected with each other. However, in the conventional device detection procedure or user interface for the audio network system, a user cannot easily verify the actual operation status.

### SUMMARY OF THE INVENTION

In view of the foregoing, it is an object of the present invention to provide an improved audio network system in which the user can easily verify the actual operation status of the audio network system having the fault tolerance and the expandability in the system as well as a display method for displaying the transmission path of the transmission frame in the audio network system.

In order to accomplish the above-mentioned object, the present invention provides an audio network system which comprises at least one network including one or more devices coupled with each other via a cable in a form of a cascade network or a ring network and a control device connected to one of the devices or provided in one of the devices, wherein each of the devices has at least one network interface provided with a first terminal and a second terminal, said cascade network is formed by coupling with a cable between the second terminal of the network interface of a first device and the first terminal of the network interface of a second device, coupling with a cable between the second terminal of the network interface of the second device and the first terminal of the network interface of a third device, and repeating such coupling in order, and said ring network is formed by coupling with a cable between the second terminal of the network interface of an end device of the cascade network and the first terminal of the network interface of a top device in the cascade network, and wherein the audio network system further comprises: a path forming section adapted to form a ring transmission path circulating through a plurality of devices coupled with each other in the form of the cascade or ring network; a specifying section adapted to specify one of the devices as a master node so that the device specified as the master node generates a transmission frame at every predetermined period to transmit the generated transmission frame to the ring transmission path, and the transmission frame containing a plurality of audio signals and control data circulates through the plurality of devices along the ring transmission path;

an audio signal path control section adapted to specify one device as a source and another device as a destination so that the device specified as the source writes an audio signal into the transmission frame while the transmission frame passes through the device, and the device specified as the destination reads the audio signal from the transmission frame while the transmission frame passes through the device; and a control section adapted to transmit control data from the control device to the respective devices through the circulating transmission frame and controls the devices in accordance with the control data, wherein the path forming section is further adapted use an end device of the plurality of devices coupled with each other in the form of the cascade network and having formed the ring transmission path therein to negotiate with an additional device newly connected to the cascade network in the form of a cascade or a ring with a cable and incorporate the additional device into the ring transmission path if a response from the additional device is affirmative, and wherein the audio network system further comprises: a first detecting section adapted to detect the plurality of devices existing in the ring transmission path formed in one network of the at least one network and a coupling order of the detected devices coupled in sequence via the cable; and a display section adapted to graphically display images of the detected devices in the ring transmission path formed in the one network along with cable images indicative of coupling between the images of the detected devices in accordance with the detected coupling order on a display of the control device.

The audio network system according to the present invention can be configured such that at least one of devices in the ring transmission path formed in a first network of the at least one network is a bridge device which has another network interface connected to a second network of the at least one network in the audio network system so that the second network is coupled to the first network via the bridge device; and that the second network includes one or more devices coupled with each other via a cable in a form of a cascade network or a ring network, another ring transmission path is formed through a plurality of devices included in the second network, one of the plurality of devices operates as a master node generating a transmission frame at every predetermined period to transmit the generated transmission frame to the ring transmission path, the transmission frame for carrying a plurality of audio signals and control data circulates between the plurality of devices along the ring transmission path, a certain device among of the plurality of devices writes an audio signal into the transmission frame while the transmission frame passes through the certain device, and another device reads the audio signal from the transmission frame while the transmission frame passes through the other device; and that the bridge device is adapted to read the audio signals and the control data from the transmission frame of either one of the first and second networks and write the audio signals and the control data into the transmission frame of another one of the first and second networks, and the control section is adapted to remotely control the respective devices in the ring transmission paths in accordance with the control data transmitted to the respective devices through the transmission frame, and wherein the audio network system further comprises: a second detecting section adapted to detect the plurality devices existing in the ring transmission path formed in the second network and a coupling order of the detected devices coupled in sequence via the cable, and wherein said images of the detected devices displayed by the display section are first images of the devices in the first network detected by the first detection section, and the display section is further adapted to graphically display, on the display of the control device, second images of the devices, detected by the second detection section, in the ring transmission path formed in the second network along with cable images indicative of coupling between the second images of the devices in accordance with the coupling order detected by the second detection section and one or two cables images indicative of coupling between the second images and an image of the bridge device in the first images.

According to the present invention, among the plurality of devices coupled with each other in the form of the cascade or the ring, the devices in the transmission path where the same transmission frame carrying the audio signals circulates are displayed on the display of the control device in the physical connection order, and therefore the present invention can achieve an advantageous benefit that a user can easily verify a range of the devices which are objects of control as the audio network system and a condition of the physical connections thereof. The user can verify through the display whether a desired transmission path is formed or not, and if the desired transmission path is not formed, the user can specify the problem device and change a setting of the device or the physical connection of the device.

In addition, in such a case where the plurality of devices are coupled with each other in the form of the ring, the user can verify whether the transmission path circulating the transmission frame therethrough is formed in a loop manner along the ring or in a cascade manner by being looped back in a middle device.

In addition, in a case where two networks are connected with each other via one device, the user can verify whether the device is connected as one audio network expanding two audio networks (full bridge), whether the device is connected as two independent audio networks (partial bridge), or whether no connection (bridge) is made as the audio network even though the device seems to be connected.

### BRIEF DESCRIPTION OF THE DRAWINGS

FIG. 1 is a diagram showing an example of an entire connection of an audio network system which comprises a plurality of networks;

FIG. 2 is a block diagram showing an example of a construction of a mixing system as one network in the audio network system according to the present invention;

FIGS. 3(a)-3(c) are block diagrams showing electrical hardware constructions of typical devices composing the mixing system of FIG. 2, in which FIG. 3(a) shows a console, FIG. 3(b) shows an engine, and FIG. 3(c) shows an I/O device;

FIG. 4 is a view illustrating a connection cable connected to a network I/O of FIG. 3;

FIG. 5(a) is a diagram showing an example of a construction of a transmission frame transmitted in the network, FIG. 5(b) is a diagram illustrating a transmission channel assignment to an audio signal area, and FIG. 5(c) is a diagram showing a correspondency of N transmission channel assignment of FIG. 5(b) and nodes in the network;

FIG. 6 shows a display example of an audio network view screen related to the audio network system of FIG. 1;

FIG. 7 shows device lists which the devices have;

FIG. 8 is a flow chart showing a process performed in response to receiving a network view display operation;

FIG. 9 is a flow chart showing lower row display processing;

FIG. 10 is a flow chart showing a process performed when the device newly detects an adjacent device;

FIG. 11 is a flow chart showing a process performed when the device detects vanishing of the adjacent device;

FIG. 12 is a flow chart showing a process performed when the device receives device list update detail;

FIG. 13(a) to FIG. 13(c) are views to illustrate the change of the network configuration due to incorporation of the devices;

FIG. 14(a) and FIG. 14(b) are views to illustrate the change of the network configuration due to a loop; and

FIG. 15(a) and FIG. 15(b) are views to illustrate the change of the network configuration due to the vanishing of the device.

### BEST MODE FOR CARRYING OUT THE INVENTION

Hereinafter, the audio network system of the present invention will be described with reference to the accompanying drawings.

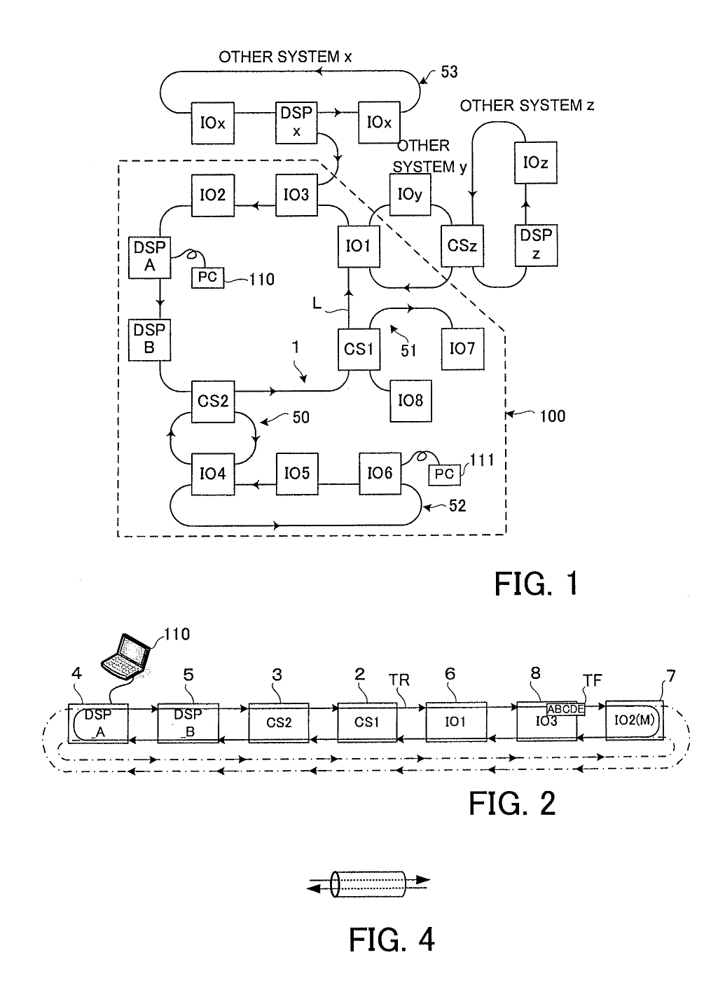

FIG. 1 shows constructions of all networks which are physically connected with each other and capable of communicating therebetween using a transmission frame. Four audio network systems including an audio network system 100 are formed in the all networks. Each network system comprises one or more networks, and one or more devices are connected with each other in each network. In FIG. 1, the system 100 comprises four networks 1, 50, 51, and 52 (a range encircled with dotted lines in FIG. 1) that are interconnected by a “full bridge” described later, and each of other three systems x, y, and z is comprises one network. The four audio network systems are interconnected by a “partial bridge” described later. In FIG. 1, one connecting network connects the system 100 and the system x, and another connecting network connects the system 100 and the systems y and z.

Each of the networks 1, 50, 51, 52, 53, etc. of FIG. 1 comprises a plurality of nodes (devices) that are connected in a cascade manner or a ring manner. A plurality of blocks depicted in FIG. 1 are nodes (devices) which are components of the respective networks, and a line L connecting between the blocks shows a connection cable between the nodes. A transmission path for a transmission frame containing audio signals of a plurality of channels is formed between the nodes (devices) composing a single network, and data such as the audio signals is transmitted and received between the nodes in a form of the transmission frame circulating through the transmission path. As described later, the node has one or two interfaces for connecting one or two networks, and each interface has two terminals having directional properties for connecting the connection cable. One of the terminals is an upstream side terminal for connecting to the node of the upstream side, and anoother of the terminals is a downstream side terminal for connecting to the node of the downstream side. Arrows in a direction from the upstream side to the downstream side are given to each network in FIG. 1.

FIG. 2 shows an example of a construction of a single network 1 that is a component of the network system 100 of FIG. 1. A group of a plurality of devices connected with each other in the network 1 are referred to as a “subsystem 1” that means a part of the system 100. The subsystem 1 includes two consoles (CS1, CS2) 2 and 3, two signal processing engines (DSP_A, DSP_B) 4 and 5, and three input/output devices (IO1, IO2, and IO3) 6, 7, and 8. The system 100 performs signal processing (such as control of characteristics or mixing) for the plural audio signals that are received from the input/output devices (IO1 through IO8) 6, 7, and 8 with the signal processing engines 4 and 5 in accordance with control by the consoles (CS1, CS2) 2 and 3 and an operation of outputting the result of the signal processing (output signal) from the input/output devices (IO1 through IO8) 6, 7, and 8. The reason why the two signal processing engines (DSP_A, DSP_B) 4 and 5 are provided in the system 100 is because a mirroring operation should be performed. Although either engine performs the same signal processing, only the output signal from one side (engine in operation) is output from the input/output devices (IO1 through IO8) normally, but the output signal from another side (engine in standby) is not output. When a failure occurs in the engine in operation and a normal output signal is not output, the output signal from the engine in standby is output from the input/output device.

### <<Configuration of Console>>

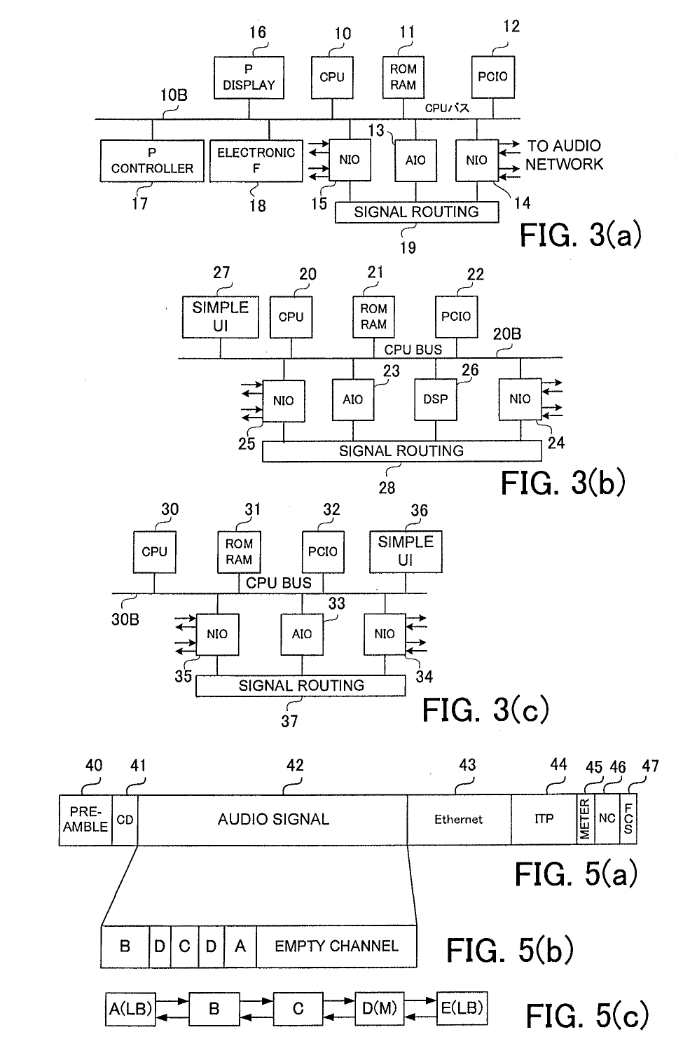

FIG. 3(a) shows an example of an electrical hardware construction of the consoles 2 and 3. The console 2 or 3 is a control device that remotely controls the operation of the devices in the mixing system and includes a CPU (Central Processing Unit) 10, memory 11 including a ROM (Read Only Memory) and a RAM (Random Access Memory), a PC interface (PC_I/O) 12, an audio interface (A_I/O) 13, two network I/O (N_I/O) 14 and 15, a panel display (P display) 16, a panel controller (P controller) 17, and an electric fader 18, in which components are connected to each other through a CPU bus 10B. In addition, the A_I/O 13 and the N_I/O 14 and 15 are connected through an audio bus (signal routing) 19.

The CPU 10 executes a control program stored in the memory 11 and controls the whole operation of the console. The memory 11 is used as a loading area or a work area of the program executed by the CPU 10. In addition, the memory 11 is provided with an area for a current memory for storing operation parameters (parameters for each device) of a data configuration same as current operation parameters for each of the devices exiting in a control range of the system 100 (the range of remote control by the console) and an area for storing a device list described later. During an operation of the system, the parameters for each device stored in the current memory of the console is synchronized with (dynamically agreed with) operation parameters stored in a current memory in each device to be remotely controlled by a conventionally-known synchronization technique. In other words, when the value of the parameter for a certain device stored in the current memory of the console is changed in response to the user operation through the console, the change is transmitted to the device through the network, and the value of the operation parameter stored in the current memory of the device is remotely changed in the same manner. On the other hand, when the value of the operation parameter stored in the current memory of a certain device is changed in response to the user operation at the device, the control data indicating the change is transmitted to the console through the network, and the parameter for the device stored in the current memory of the console is remotely changed in the same manner.

The P display 16, the P controller 17, and the electric fader 18 are user interfaces that are provided on the operation panel of the console. The P display 16 displays various display screen images according to display control signals supplied from the CPU 10 through the bus 10B and receives a user's instruction based on information displayed on the display screen. The P controller 17 is a group of controllers arranged on the operation panel. The electric fader 18 is a controller of a fader type operable by the user, and an operating position of the fader 18 can be automatically controlled in accordance with a drive control signal supplied from the CPU 10. The CPU 10 adjusts a value of any parameter in response to a user's operation of the P display 16, the P controller 17, or the electric fader 18. In this disclosure, the terms “adjusting a value of a parameter” means that a value of a particular parameter for a certain device assigned to a controller operated by a user is changed to another value in response to the user's operation to thereby renew the value of the particular parameter stored in the current memory of the console, and that if the certain device is not the console itself, a notification of the change is supplied to the certain device over the network, and a value of the particular parameter stored in the current memory of the certain device is remotely changed (renewed) to the same as the renewed value in the current memory of the console. Operation of hardwares provided in each device, that is, various audio signal processing blocks (such as A_I/O, N_IO, and a DSP section as described later), PC_I/O, or the like are controlled according to the operation parameters stored in the current memory of the device. In addition, a display according to the operation parameters stored in the current memory of the device is produced on the user interface of the device.

The A_I/O 13 is an interface for inputting and outputting the audio signal with the plurality of channels and includes a plurality of input ports for inputting an analog audio signal or a digital audio signal from an external device and a plurality of output ports for outputting the analog audio signal or the digital audio signal to the external device. In addition, the A_I/O 13 also includes a mechanism for performing analog-digital conversion (AD conversion), digital-analog conversion (DA conversion), and digital conversion (format conversion). Furthermore, a volume level used for inputting an audio signal from the outside via an individual input port, a volume level used for outputting the input audio signal to an audio bus via an L transmission channel, a volume level used for taking into an individual output port an audio signal from the audio bus via the L transmission channel, a volume level used for outputting the taken audio signal to the outside via the output port, or the like is controlled respectively with a corresponding parameter stored in the current memory of the concerned device (in this case, the console).

The first N_I/O 14 and the second N_I/O 15 are interfaces which connect the concerned device to the audio network and have necessary mechanisms for transmitting/receiving the transmission frame through the audio network, reading out various data including a necessary audio signal (waveform data) and control data from the transmission frame, writing the various data including the waveform data and the control data into the transmission frame, transmitting and/or receiving the waveform data through an audio bus 19, and transmitting and/or receiving the control data or the like through the CPU bus 10B. An N transmission channel used for reading out an audio signal from the transmission frame via each of N_I/O 14 and 15, an L transmission channel used for outputting the readout audio signal to the audio bus via each of N_I/O 14 and 15, an L transmission channel used for taking an audio signal from the audio bus into each of N_I/O 14 and 15, an N transmission channel used for writing the taken audio signal into the transmission frame via each of N_I/O 14 and 15, or the like is controlled respectively with a corresponding parameter stored in the current memory of the concerned device (in this case, the console).

Each of the first N_I/O 14 and the second N_I/O 15 has two terminals at the upstream side and the downstream side, and each of the two terminals can be connected with a connection cable for the audio network. Each of the two terminals is constructed, as shown with a pair of arrows directing opposite to each other in FIG. 3, so as to be capable of bi-directionally transmitting and receiving the transmission frame between the terminal and one device connected to the terminal in question. The details of a connection of the devices and a connection of the networks through the first N_I/O 14 and the second N_I/O 15 will be described later.

The audio bus 19 is a local bus which transmits the digital audio signals (waveform data) of the plurality of channels in a time division manner, by one sample at every sampling period, among the A_I/O 13 and two N_I/O 14 and 15. The A_I/O 13 and two N_I/O 14 and 15 synchronize with each other timing of waveform data processing by a conventionally-known technique using a word clock. In other words, any one of the A_I/O 13 and two N_I/O 14 and 15 is set as a word clock master, the remains other than the word clock master are set as word clock slaves. The word clock master generates the word clock, and the word clock slaves generate a word clock at the timing in synchronization with the word clock generated by the word clock master and process the waveform data at the timing of the sampling period based on the generated word clock.

The consoles 2 and 3 can connect the personal computer (PC) to the outside through the PC_I/O 12. The PC connected to the console 2 or 3 through the PC_I/O 12 can be used as a control device for remotely controlling the operation of the devices in the network 1. The PC is a general-purpose computer that includes a CPU, ROM, RAM, a display, a mouse controller, a keyboard, and the like.

### <<Construction of Engine>>

FIG. 3(b) shows an example of a construction of one of the engines 4 and 5. One engine includes a CPU 20, memory (ROM and RAM) 21, a PC_I/O 22, an A_I/O 23, two N_I/O 24 and 25, a signal processor (DSP section) 26, and a simple user interface (simple UI) 27, in which respective parts are connected with each other through a CPU bus 20B. In addition, the A_I/O 23, N_I/O 24, and the DSP section 26 are connected with each other via an audio bus (signal routing) 28. The CPU 20 executes a control program stored in the memory (ROM and RAM) 21 and controls the whole operation of the engines 4 and 5. The memory 21 of the engines 4 and 5 stores the area of the current memory storing the operation parameters as described above or the area for storing the device list as well as various data required for the operation of the engine in question such as a microprogram for the DSP section 26. In addition, the memory 21 has an area that stores the device list described later. The simple UI 27 is a power supply switch, an LED indicator for operation check, or the like.

The DSP section 26 executes various microprograms according to the command from the CPU 20 and performs various digital signal processing to the audio signal. In other words, based on the value of the corresponding parameter stored in the current memory of the device (in this case, engine), the DSP section 26 takes therein the audio signal from a specified L transmission channel of the audio bus, performs the digital signal processing to the taken-in audio signal, and outputs the processed audio signal to the specified L transmission channel of the audio bus. The signal processing executed by the DSP section 26 is mixing processing, effect impartment processing, volume level control processing, and the like. Signal processing results of the DSP section 26 are transmitted to the A_I/O 23 and the N_I/O 24 and 25 through the audio bus 28. The DSP section 26 may be configured with one DSP (Digital Signal Processor) or may be configured with multiple DSPs interconnected through the bus to process the signal in a distributed manner using the multiple DSPs.

In addition, the A_I/O 23, the N_I/O 24 and 25, and the audio bus 28 are configured in the same manner as the corresponding components in FIG. 3(a). The PC can be connected to the engines 4 and 5 through the PC_I/O 22. In the subsystem 1 of FIG. 2, the PC 110 is connected to the engine 4 (DSP_A).

### <<Configuration of Input/Output Device>>

FIG. 3(c) shows an example of a construction of the input/output devices 6, 7, and 8. The input/output device includes a CPU 30, a memory (ROM and RAM) 31, a PC_I/O 32, an A_I/O 33, a first N_I/O 34, a second N_I/O 35, and a simple user interface (simple UI) 36, in which respective parts are connected with each other through a CPU bus 30B. In addition, the A_I/O 33, the first N_I/O 34, and the second N_I/O 35 are connected through an audio bus (signal routing) 37. A group of the CPU 20 and the memory (ROM and RAM) 21 is a control section for controlling an entire operation of the input/output device. In addition, the memory 21 is provided with an area of the current memory for storing the operation parameters described above and an area for storing the device list. The simple UI 25 comprises a simple indicator and a group of some controls.

The A_I/O 33, two network I/O (first N_I/O 34 and second N_I/O 35), and the signal routing 28 are configured in the same manner as the corresponding components in FIG. 3(a). The input/output devices 6, 7, and 8 are the devices responsible for input/output functions of the audio signal and have a plurality of audio signal input and output ports as the A_I/O 33. The PC can be connected to the input/output devices 6, 7, and 8 through the PC_I/O 32.

### <<Connection Between Devices>>

Each of the devices 2-8 can be connected to (i.e., coupled with) an adjacent device on the upstream side of the device in question via a connection cable connected to the upstream terminal of one of N_I/O (14, 15, 24, 25, 34, and 35) and also can be connected to an adjacent device on the downstream side of the device in question via a connection cable connected to the downstream terminal. For example, in FIG. 2, CS1 is connected to CS2 on the upstream side and IO1 on the downstream side. The adjacent devices of seven devices 2-8 are connected to each other via the connection cables in sequence, and therefore one network (subsystem 1) which comprises seven devices 2-8 connected in a form of a cascade network or a ring network is formed.

In FIG. 2, solid lines shows a cascade connection manner in which the devices 2-8 are physically connected in a form of a single line so that the engine 4 (DSP_A) and the input/output device 7 (IO2) are located at both ends. The connection cable for connecting between two adjacent devices is configured to be capable of bi-directionally communicating the transmission frame with one cable as illustrated in FIG. 4, for example. In this case, the devices located at positions other than the both ends of the cascade connection operate in such a manner that a transmission frame received at one terminal of a certain N_I/O is not internally looped back but transmitted from another terminal of the certain N_I/O (straight transfer), but the devices located at the ends operate in such a manner that a transmission frame received at one terminal of a certain N_I/O is internally looped back to transmit from the same terminal of the same N_I/O (loopback transfer), and therefore, by only forming the cascade connection in which the individual one of connection cables is connected between every two adjacent devices of the devices 2-8, a ring transmission path TR in which the transmission frame TF circulates through all devices 2-8 can be formed. A construction or mechanism for forming a ring transmission path TR circulating through the plurality of devices 2-8 coupled with each other in the form of the cascade or ring network in one network (network 1, herein) corresponds to a “path forming section” which is one of elements recited in claim 1. Such a condition where the transmission path TR is formed as described above is referred to as a “cascade” in this disclosure. In FIG. 2, an arrow of the transmission path TR indicates a direction in which the transmission frame TF flows. In FIG. 2, each device reads various data from the transmission frame or writes the various data into the transmission frame at an upper side of the transmission path TR in the transmission frame passing through the device. In other words, each device other than the both ends of the cascade reads and writes the data from and into the transmission frame when the transmission frame passes from the upstream side to the downstream side, while each device located at any of the both ends of the cascade reads and writes the data from and into the transmission frame at the time of transmission to the downstream side or reception from the upstream side.

The devices 2-8 can be physically connected in a form of a ring, which has no ends, by connecting between the engine 4 (DSP_A) and the input/output device 7 (IO2) located at the cascade ends with a further connection cable. In a case where the devices located at the both ends of the cascade are directly connected with each other as aforementioned, the devices located at the both ends stop the operation (or a role) as an end device of the cascade (loopback transfer) and start a new operation (or a role) as an intermediate device similar to the operation of the other devices located at positions than the both ends (namely, straight transfer), and therefore, the ring transmission path TR for transmitting the transmission frame is formed double on the plurality of devices connected in a form of a ring as shown in FIG. 2 with alternate long and short dash lines. Such a condition where the transmission path TR is formed as described above is referred to as a “loop” in this disclosure. In the loop, two adjacent devices are connected with a bi-directionally communicable connection cable, and the devices in the loop operate to transmit the transmission frame received at one N_I/O from the other N_I/O without the internal loopback (straight transfer). In this case, even if the connection between any two devices among the devices connected in a ring is disconnected, the device on the both sides of the disconnection part respectively start the operation of the device at the end of the cascade (loopback transfer), and thus the device can be shifted to the “cascade” mode described above and maintain the circulation of the transmission frame, so that the security and reliability of the network can be improved. Each device in the ring reads and writes various data from and to the transmission frame when the transmission frame passes the device from the upstream side to the downstream side, while this operation is the same as that of the device other than that at the ends in the cascade.

### <<Master Node>>

Any one of the plural devices 2-8 (in FIG. 2, “IO2”) in one network (subsystem 1) becomes a “master node” of the network. This configuration corresponds to a specifying section that specifies one of the devices 2-8 as the master node. The master node performs the operation of generating the transmission frame TF at every one sampling period of specified sampling frequency and issuing the generated transmission frame TF to the network. All devices other than the master node become slave nodes, and the slave nodes respectively execute the transfer processing of receiving the transmission frame from the upstream side of the transmission path TR and transferring it to the downstream side of the transmission path TR. That is, the master node is an extreme upstream node in the transmission path TR, the transmission frame circulates through the transmission path TR, and finally, the transmission frame returns from an extreme downstream node (in FIG. 2, “IO3”) to the master node.

In addition, the master node becomes a word clock master of the word clock that synchronizes the timing of the sampling period for processing the waveform data in the devices 2-8 of the network. Each slave node synchronizes with the timing of start of the reception of one transmission frame TF to generate the word clock that is a signal for defining the sampling period for processing the waveform data, and therefore the slave node synchronizes the processing timing of the waveform data with the timing of the sampling period (word clock) in the master node.

### <<Configuration of Transmission Frame>>

FIG. 5(a) shows an example of a data configuration of the transmission frame transmitted in the audio network. A format of the transmission frame complies with a frame format of Ethernet (trademark) and includes a preamble 40, a control data (CD) storage area 41, an audio signal area 42, an Ethernet (trademark) data area 43, an ITP area 44, a meter area 45, an NC area 46, and a frame check sequence (FCS) area 47. In FIG. 5(a), the left side of the drawing is a front of the transmission direction of the frame, that is, a head of the transmission frame.

The preamble 40 stores a preamble that is defined by the IEEE (Institute of Electrical and Electronic Engineers) 802.3 as well as an SFD (Start Frame Delimiter), a destination address, a source address, length of the concerned transmission frame, or the like. The CD storage area 41 stores the data for controlling the data included in the concerned transmission frame (such as number of the transmission frame or a sampling delay value). The audio signal area 42 has multiple transmission channels (for example, 256 channels) and stores every one sample of the waveform data in each transmission channel.

The Ethernet (trademark) data area 43 is an area where each device writes the frame data in an Ethernet (trademark) format, in which the area stores the control data for remote control written by the control device (consoles 2 and 3 or PC) or the data such as a connection status or an operating status of the each device, for example. When the frame data larger than the Ethernet (trademark) data area 43 in size is transmitted, by using the well-known technique, the transmission side transmits multiple divided data in multiple transmission frames, and the reception side combines multiple data acquired from the multiple transmission frames in specified order and reconstructs the frame data before it is divided. A construction or mechanism for transmitting the control data from the control device to the respective devices through the transmission frame and controlling the respective devices in accordance with the control data corresponds to a “control section” which is one of elements recited in claim 1. The ITP area 44 is used to transmit a command and a response to the command between adjacent nodes. The meter area 45 stores the data for a level indication meter. The NC area 46 stores the data indicating the network configuration. The FCS 47 stores error check code data for detecting an error of the frame defined by the IEEE 802.3. In this network, the audio signal and the control data are transmitted by the transmission frame that circulates through plural devices. Accordingly, when the attention is focused on one network, a range where the audio signal is transmitted and a range where the control data is transmitted are the same as one another. The situation in which the audio signal reaches but the control data does not reach cannot occur.

By appropriately setting the size of one transmission frame based on the conditions such as the sampling period or transmission speed of the network (transmission bandwidth), the whole transmission frame can be circulated through the transmission path TR (path that passes through all devices in the network) in one sampling period.

### <<Assignment to N Transmission Channel>>

FIG. 5(b) is an assignment example of devices A through E to the multiple N transmission channels of the audio signal area 42, and FIG. 5(c) is a network configuration example including the devices A through E. In FIG. 5(c), a network including the devices A through E connected in a cascade is shown. The device D is the master node, and the device A and the device E are set as loop-backs (LB) that are loopback ends of the transmission frame. The transmission frame generated by the master node D is transmitted to the downstream device E and circulates through the ring transmission path passing through all devices A through D in the order of D→E (LB)→D→C→B→A (LB)→B→C→D. As described above, the read and write of the data from and to the transmission frame by each device are executed at the time when the transmission frame passes through the device from the upstream side to the downstream side, and therefore, in this case, the read and write are executed in the order of D→E→A→B→C.

In FIG. 5(b), blocks A through E described with alphabetic characters denote the N transmission channels assigned to the devices A through E corresponding to the alphabetic characters. The number of the N transmission channels required for the devices are assigned to the devices in the network. Assignment of the N transmission channels is managed by the master node. The area assigned to each device (the N transmission channel secured by each device) can be used as the channel in which only the device exclusively writes the waveform data. The N transmission channel not assigned to any of the devices is an “empty channel (empty ch)”.

The N_I/O (reference numerals 14, 15, 24, 34, and 35 of FIG. 3) of the devices A through E writes the waveform data (audio signal) to the N transmission channel assigned to the devices A through E and reads the waveform data (audio signal) from the desired N transmission channel during the processing of receiving the transmission frame from the upstream device in a transmission direction of the transmission frame and transferring it to the downstream side. The desired N transmission channel reading the waveform data is an N transmission channel that is assigned to a source device of the waveform data. By reading and writing the waveform data and the like from and to the transmission frame circulating once through the transmission path at every sampling period, all devices can receive the waveform data and the like in approximately real time even though the waveform data and the like are written from any devices in the network to the transmission frame. Preferably, the master node D receives to the end of the transmission frame circulating once through the transmission path and then starts to generate and transmit a next transmission frame. That is, the operation described above by the N_I/O (reference numerals 14, 15, 24, 34, and 35 of FIG. 3) of the devices A through E is an audio signal path control section.

The devices other than the devices A and E as the loopback ends pass the transmission frame twice in a forward path and a return path; however, read and write of the waveform data and the like is executed only once at the time of passing the transmission frame from the upstream side to the downstream side of the device.

The transmission method of the transmission frame through the audio network applicable to the network 1 can be executed according to the technique disclosed in Patent Document “Japanese Patent Application Publication No. 2008-99264”. Various technical matters such as the size of the transmission frame and the specification of the network disclosed in the document is applicable to the present embodiments.

### <<Connection Between Networks>>

The devices 2-8 in the subsystem 1 respectively have two network I/Os (a first N_I/O 14, 24, or 34 and a second N_I/O 15, 25, or 35) as described above. The first N_I/O 14, 24, or 34 of the two N_I/Os is used to connect the concerned device with the other device in the other network, and the second N_I/O 15, 25, or 35 is used to connect one network with the other network.

The device connecting between two networks through two N_I/Os operates as a connection node (bridge device). The user can set either a “full bridge” mode for coupling one connected network as the expansion of the other network or a “partial bridge” mode for coupling it as a separate independent network to the bridge device, as the operation of the connection node. In an example of FIG. 1, the console 2 (CS1) and the console 3 (CS2) in the network 1 are respectively set to the “full bridge”, and the input/output device 6 (IO1) and the input/output device 8 (IO3) are respectively set to the “partial bridge”. The setting operation relating to the bridge device is executed by using the user interface (P display 16, P controller 17, or simple UI 27, 36) in which the individual connection node (bridge device) has, for example, or the user interface of any control device in the audio network system 100, and the bridge device sets the parameters of two N_I/Os of the connection node stored in the respective current memory of the control device and the connection node in response to the setting operation. In addition, the bridge setting may be performed such that the CPU of the individual connection node (bridge device) controls the setting of itself in response to the command by the user, or the bridge setting in each connection node may be remotely controlled by the control device or the master node.

The connection node executes the function of “bridging” of the audio signal between two networks in an operating manner according to the “full bridge” or the “partial bridge” when the sampling frequencies in two networks connected by the connection node are agreed with each other (in other words, when the connection node is set as the master node in at least one of two networks). The operation of the “bridging” of the audio signal means that the audio signal is transmitted and received between two networks through the connection node.

### <<Full Bridge>>

In the case where two networks are connected according to the full bridge setting, the required numbers of the N transmission channels for respective devices in both networks are assigned to the audio signal area 42 of the respective transmission frames flowing through the respective networks. In other words, the transmission speed and the number of the N transmission channels of the transmission frame are common in both networks, and the N transmission channel assignment is performed to the audio signal area 42 of the common transmission frame. The N transmission channel assignment in both networks is executed by any one of the master nodes in two networks connected in the full bridge.

The connection node reads the waveform data from all N transmission channels assigned to any device in one network and writes all readout waveform data into the same N transmission channel of the transmission frame flowing in the other network through the second N_I/O (15, 25, or 35), respectively. In addition, the waveform data is read from all N transmission channels assigned to any device in the other network through the second N_I/O, and all of the read waveform data are respectively written into the same N transmission channel of the transmission frame flowing in the one network through the first N_I/O. Accordingly, the audio signal written in the audio signal area 42 of the transmission frame is identical in one network and the other network, whereas it is equivalent to the manner in which one transmission frame circulates through two networks in terms of the audio signal.

In other words, in the case of the full bridge setting, each device in two networks can transmit and receive the audio signal for each N transmission channel to and from any device in the other network in the same manner as each device in the network to which the device belongs. Therefore, two networks connected with the full bridge uses the resources in the other network in the same manner as the resources in the concerned network and can operate as a network system that executes one signal processing with two networks as a whole. That is, one network is coupled to the other network as the expansion of the concerned network.

### <<Partial Bridge>>

In the case where two networks are connected according to the partial bridge setting, the assignment of the device to the N transmission channel of the audio signal area 42 of the respective transmission frames flowing through the respective networks is executed to only the device in the concerned network similar to the manner described on FIG. 5(a). Therefore, in this case, the transmission speed of the transmission frame in two networks and the number of the N transmission channels are different, and the assignment to the N transmission channel of the audio signal area 42 of the transmission frame differs from each network.

The connection node set as the partial bridge reads the waveform data of each N transmission channel that is set to bridge among the N transmission channels written by the respective devices in the concerned system from the transmission frame flowing in one network through the first N_I/O (14, 24, or 34) and writes the readout waveform data to the N transmission channel assigned to the concerned connection node in the transmission frame flowing in the other network (network for connection) through the second N_I/O (15, 25, or 35). In addition, from the transmission frame flowing in the network for connection through the second N_I/O, the connection node can read the waveform data of each N transmission channel that is set to bridge among the N transmission channels assigned to the connection node of any other system connected to the network for connection and write the readout waveform data to the N transmission channel assigned to the concerned connection node through the first N_I/O.

Accordingly, in the case of the partial bridge setting, each device in one network connected to one network for connection can receive the audio signal that is set to bridge at the connection node of the other system in the audio signal of the other system connected to the network for connection by bridge setting at the connection node of one system; however, there is no way to receive the audio signal that is not set to bridge at the connection node of the other system. The partial bridge setting is to connect the connection node of a certain system with the network for connection that is for physically connecting a system with a system, and each system operates as one independent audio signal processing system (individual system).

In the connection example of FIG. 1, the network 50 and the network 51 are connected to the subsystem 1 with the full bridge setting, and furthermore, the network 52 is connected to the network 50 with the full bridge setting. In this case, the subsystem 1 and the networks 50 through 52 (a range encircled with dotted lines in FIG. 1) operate as an audio network system 100 that executes one signal processing as a whole. The control device (CS1, CS2, PC 110, or PC 111) in the system 100 can store the data required for the remote control of all devices in the system 100 in the current memory and remotely control each device belonging the other network in the system 100 in the same manner as each device in the network to which the control device itself belongs.

On the other hand, the other systems x and y are connected to the subsystem 1 with the partial bridge setting, and furthermore, the other system z is connected to the other system y, whereas the other systems x, y, and z operate as the audio signal processing system independent of the subsystem 1. The control device in the network system 100 does not remotely control the devices belonging to the other systems x, y, and z only.

In the network with the configuration of FIG. 1, the user needs to make sure which range the transmission frame carrying the same audio signal circulates to, or in other words, which range the audio network system 1 sharing the same audio signal is, in view of the following factor.

i) Which device the transmission path of the transmission frame in one network is specifically circulated to. That is, in plural devices physically and electrically connected to each other, the transmission path of the transmission frame in one network changes depending on the setting of each device or the situation, and therefore, even if the plural devices are physically and electrically connected to each other, all devices are not necessarily included in the transmission path.
ii) In plural devices physically and electrically connected in a ring, whether the transmission frame in one network circulates in a ring or in a cascade. That is, in plural devices physically and electrically connected in a ring, the transmission frame in one network does not necessarily circulate through the transmission path along the ring connection. In the case where the transmission frame circulates along the cascade connection instead of the ring connection, the protection by a redundancy operation does not become enabled.
iii) In the case where two N_I/Os in one device are respectively connected with one or plural devices physically, whether the one device operates as a connection node (bridge) or not. That is, in the case where two N_I/Os in one device are respectively connected with one or plural devices physically, the one device does not necessarily operate as the connection node (bridge). Either one or both of the N_I/Os may not be included in a circulating path of the transmission frame.
iv) Furthermore, whether the device operating as the connection node (bridge) is connected with the full bridge or the partial bridge. That is, in the case where two networks are connected with the connection node (bridge), the connection node does not necessarily connect two networks as the expansion of one network (full bridge) but may connect two networks as respective independent networks (partial bridge).

In order that the user can easily verify the above items, the audio network system 100 can display an “audio network view screen” on the display of each control device (console 2 or 3, or PC 110 or 111).

### <<Audio Network View Screen>>

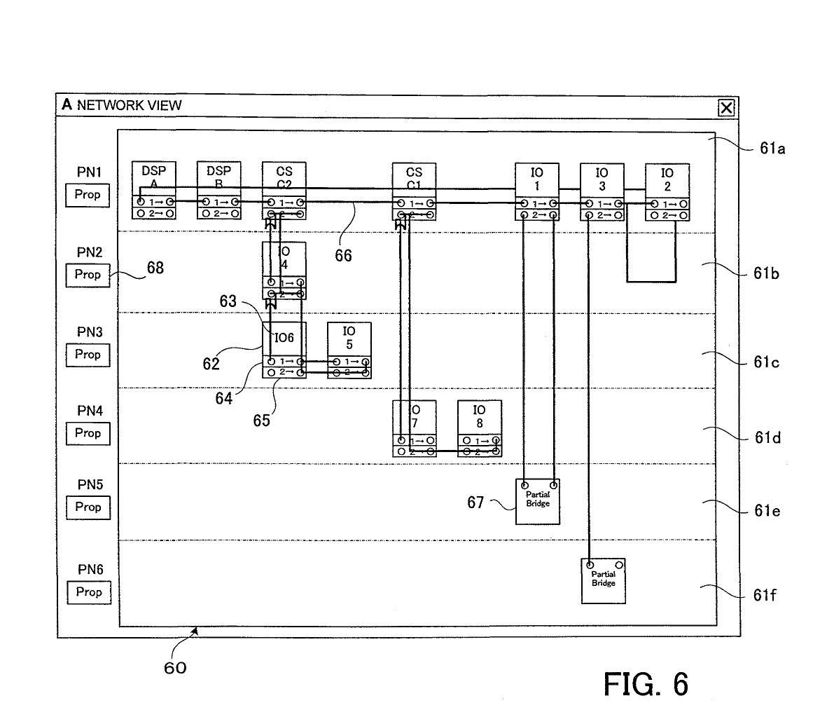

FIG. 6 is a configuration example of the “audio network view screen” that provides a graphic display of the connection status of the system 100 and shows the “audio network view screen” display on a display of the PC 110 connected to the engine 4 (“DSP_A”) in the subsystem 1. The structure that displays the audio network view screen in the display of the PC 110 or the P display 16 of the console 2 or 3 corresponds to a display in the scope of the claims.

The network display area 60 includes plural display rows 61a through 61f corresponding to respective networks configuring the system 100. The plural display rows 61a through 61f are arranged in each row in turn in the vertical direction of the screen. In FIG. 6, a separator for each of the display rows 61a through 61f is shown with a dashed line.

A top row 61a displays plural device images 62 indicating respective devices configuring a basic network in an arrangement of the horizontal direction of the screen in accordance with the connection order of the devices in the concerned network. The basic network is a network that is displayed in the top row 61a of the audio network view screen and typically a network to which the device displaying the audio network view screen belongs.

The display rows 61b through 61f after the first row displays the network connected to the connection node in the network displayed in the upper row than the concerned display rows. In the case where the connection node is set as the full bridge, a device image 62 showing each device configuring the network connected through the connection node is displayed in the display row in the arrangement of the horizontal direction of the screen in accordance with the connection order of the devices in the concerned network. That is, in order to display the screen, it is required that the connection of all devices on the transmission path of the transmission frame in the network connected through the connection node be detected. In addition, in the case where the connection node is set as the partial bridge, a partial bridge image 67 is displayed in the display row. The information of the device adjacent to the connection node in the network connected through the connection node is sufficient for the display, and the information of the other devices on the network is not necessary.

One device image 62 includes the information 63 identifying the device (device name) and images 64 and 65 showing the configuration of two network I/Os which the concerned device has. A number (1 or 2) on the N_I/O image 64 or 65 indicates a distinction between the first N_I/O and the second N_I/O. Each N_I/O image 64 or 65 is described with two circles indicating two terminals, and arrows showing between two circles indicating the terminals denote that a left terminal of them signifies the upstream side and a right terminal signifies the downstream side.

A line 66 connecting two device images 62 is the image showing the connection cable between the devices corresponding to the two device images 62. The connection cable image 66 is drawn so as to connect the terminals of the N_I/O images 64 and 65 of two device images 62. Therefore, the connection order of the devices can be recognized from the direction (upstream side or downstream side) of the terminals in the N_I/O images 64 and 65 connected with the connection cable image 66. The network view screen is arranged such that the left terminal of each device is the upstream side, the right terminal is the downstream side, and plural devices connected to the each network are shown such that a leftmost terminal is an extreme upstream side and the rightward terminal is a more downstream side; however, the arrangement may be inverted so that the left terminal of each device is the downstream side, the right terminal is the upstream side, and plural devices connected to the each network may be shown such that the leftmost terminal is an extreme downstream side and the rightward terminal is a more upstream side.

On the left side of the network display area 60, numbers PN1 through PN6 indicating the networks corresponding to the display rows 61b through 61f and property display buttons (“Prop”) 67 are displayed. By pushing the respective property display buttons 68, the property of the network of the numbers PN1 through PN6 corresponding to the buttons can be displayed on the screen.

### <<Device List>>

Contents of the audio network view screen are drawn based on the device list. The device list is generated with an audio network communication function by the N_I/O of respective devices (more specifically, MAC layer in a hierarchical model of the audio network communication protocol), and the memories 11, 21, and 31 of the respective devices store the “device list” for each network describing the information of all devices on the transmission path of the transmission frame in relation to all networks (in the case of FIG. 1, eight networks) connected to the network to which the device belongs. The configuration for generating and storing such the device list is a first detecting section that detects plural devices on the ring transmission path of one network (basic network) and the connection order of the plural device connected through the cable and a second detecting section that detects plural devices on the ring transmission path of the other network (network directly or indirectly connected to the basic network) and the connection order of the plural device connected through the cable. The audio network system 100 is configured with the basic network and all networks directly or indirectly connected to the basic network through one or plural connection nodes set as the full bridge. That is, the display of the network configuring the network system 100 of the displays on the network view screen can be executed when there are the device lists of all networks included in the network system 100. On the other hand, the partial bridge image 67 in relation to the connection network can be displayed when the connection node included in the network system 100 and set as the partial bridge has the information of an adjacent device on the concerned connection network. Therefore, instead of storing the device list for each network of “all connected networks (FIG. 1)”, only the device list of all networks included in the network system 100 (minimum device list) may be generated. Furthermore, in order to display the partial bridge image 67, the information of the adjacent device in the connection network may be acquired from the connection node included in the network system 100 and set as the partial bridge. Or, in addition to the minimum device list, the device list of the connection network (adjacent network) directly connected to the connection node set as the partial bridge may be generated.

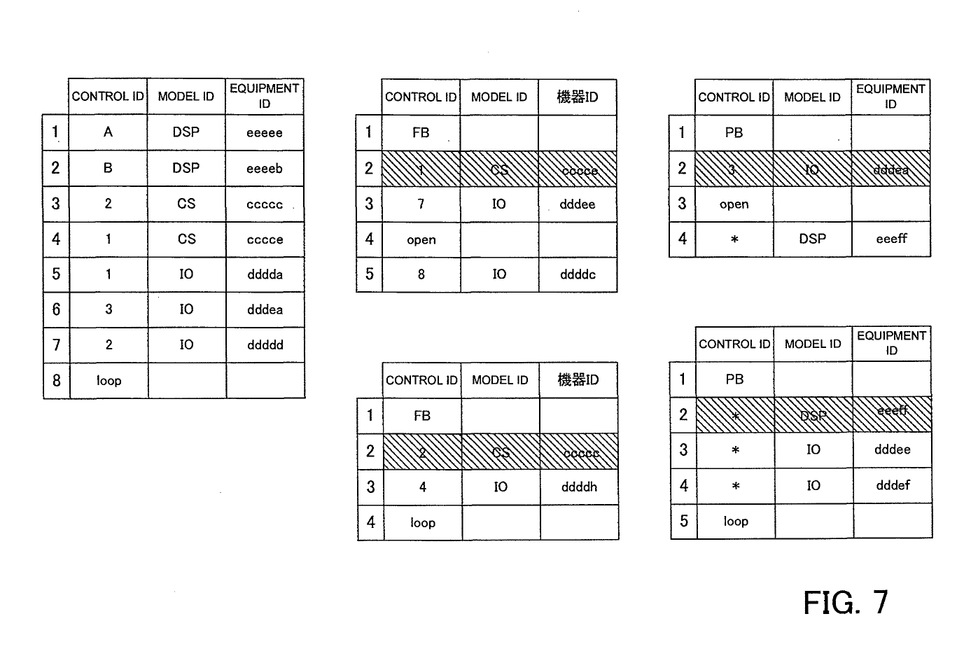

FIG. 7 is a configuration example of the device list, and plural device lists (respective device lists in relation to the network 53 including the network 1, the network 50, the network 51, the other system x, IO3, and DSPx) stored in the memory 21 of the engine 4 (“DSP_A”) in the network 1 are illustrated. The PC connected to any device in the system 100 acquires the “device list” for each network from the memory 11, 21, or 31 of the connected device and stores that in its own memory.

One device list stores a control ID, a model ID, and an equipment ID for each device as the information for identifying one or plural devices on the transmission path of the transmission frame in one network. The control ID is an ID number for remote control by the control device in order that the control device identifies the concerned device. The model ID is information for identifying a device model and differs from each model. In FIG. 7, a reference symbol “DSP” denotes the signal processing engine, a “CS” denotes the console, and an “IO” denotes the input/output device, respectively. The equipment ID is information for uniquely identifying equipment (individual piece) of the device. The device configuring one network can be identified according to the control ID, the model ID, and the equipment ID recorded on one device list. The device list is a record of the device connected in the audio network, whereas the PC connected to the device through the PC_I/O 12, 22, or 32 is considered as a part of the connected device and not recorded on the device list.

On the device list, the information identifying each device (control ID, model ID, and equipment ID) is recorded on the list in the physical connection order of the devices in the transmission path of the transmission frame in the network. The numbers at the left end of the row recorded with the information are the numbers related to the connection order. According to the recording order of the information, the connection order of the devices configuring one network can be specified.

The connection order of the devices recorded on the device list is the order in which the device storing the concerned device list is designated as the starting point. For example, FIG. 7 illustrates the device list stored in the DSP_A, and therefore the information in relation to the DSP_A is recorded to the top of the device list of the network 1. The device list of the other network has the connection node connecting the network and the network 1 at the top. In FIG. 7, the row corresponding to the connection node on the device list of the other network connected to the network 1 is shown with hatching.

In addition, the data list is recorded with, as the information indicating the connection status between the devices, either one of a loop symbol that indicates the connection from the device corresponding to the equipment ID written in the end of the list (end of the connection order) to the device corresponding to the equipment ID written in the top of the list (top of the connection order) and an open symbol that indicates the disconnection between two adjacent devices which are the device corresponding to the control ID and the equipment ID in a certain connection order of the list and the device corresponding to the equipment ID in the next connection order. Here, the next connection order of the end of the list returns to the top of the list. In FIG. 7, the information indicating the connection status between the devices is recorded in the control ID row, and, for example, the information “loop” indicating the loop is recorded in the control ID row of the row number “8” on the device list of the network 1. In addition, the information “loop” indicating the loop is recorded in the control ID row of the row number “4” on the device list of the network 50. The “loop” flag of the device list is not required for the network in which the devices are connected in a ring. For example, if the “open” is not written in the list, the device list can be considered as the “loop”.

On the device list of the other network connected to the network 1, the control ID row on the row (first row) above the row (second row) indicating the connection node executing the connection is recorded with the information indicating the bridge setting of the concerned connection node (a symbol FB indicating the full bridge mode or a symbol PB indicating the partial bridge mode). For example, the control ID row of the row number “1” on the device list of the network 50 is recorded with the “FB” as the bridge setting information. In addition, the control ID row of the row number “1” on the device list of the network 53 is recorded with the “PB” as the bridge setting information. Accordingly, it can be specified whether the connection of the concerned network to the network 1 (setting of the concerned connection node) is the full bridge or the partial bridge.

The device only belonging to the network out of the control range of the system 100 (the network 53 and the other systems x, y, and z connected to the network 1 through the connection node set as the partial bridge) is not remotely controlled, and therefore the control ID can be ignored. Accordingly, the control ID row of such a device is recorded with “don't care” as the value (for example, “*” of the row number “4” in the list of the network 53).

The CPU of the control device belonging to any network in the system 100 (the CPU 10 of the console 2 or 3, or the CPU of the PC 110 or 111) executes the processing of displaying the audio network view screen based on the device list on the display of the concerned control device (P display 16 of the console 2 or 3, or the display of the PC 110 or 111) when the CPU receives a display command of the audio network view screen from the user.

### <<Audio Network View Screen Display Processing>>

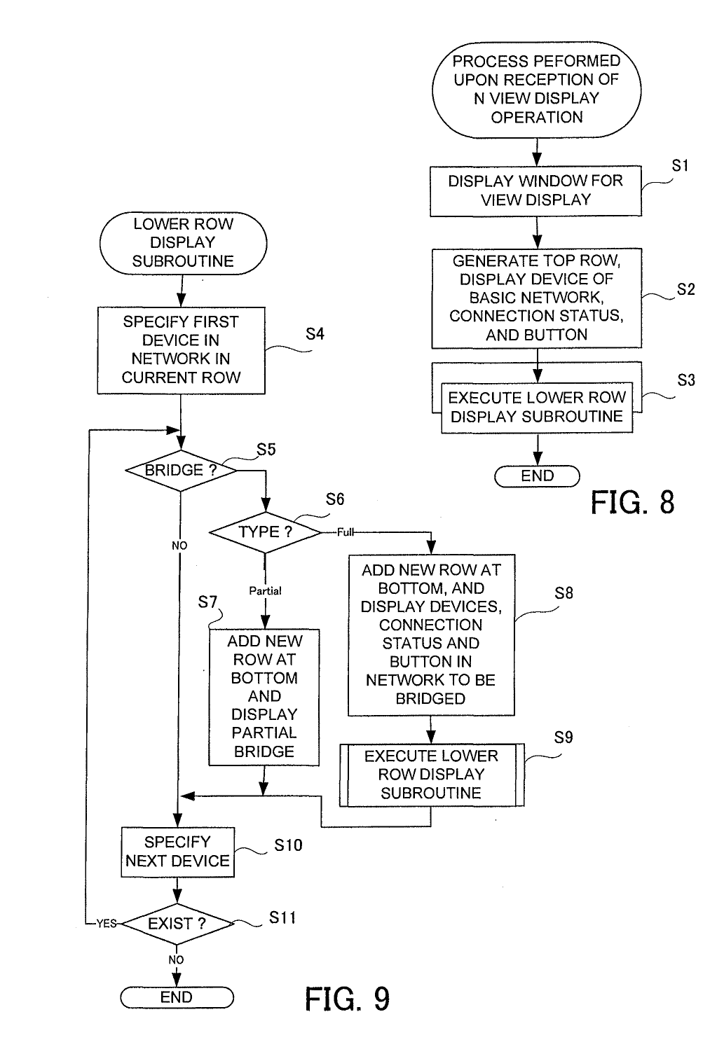

FIG. 8 is a flow chart showing a process executed by the CPU of the control device when the display command of the audio network view screen is received from the user. It is assumed that the display command is issued at the PC 110 connected to the DSP_A and the CPU of the PC 110 executes the processing.

In a step S1, the CPU displays a window for the audio network view screen on the display. The window for the audio network view screen displayed here is in an empty state in which the network display area 60 does not display the display rows 61a through 61f or the device image 62.

In a step S2, the CPU generates the top row 61a in an upper end section of the network display area 60, displays the device image 62 showing all devices configuring the basic network in the generated top row 61a, based on the device list of the network 1 (basic network) stored in the memory, in an arrangement of the horizontal direction in accordance with the connection order, and displays the connection cable image 66 connecting between the device images 62. The device name 63 displayed in the device image 62 may be an appropriate name that can identify the device such as a combination of the model ID and the control ID. Along with the generation of the top row 61a, the CPU displays the property display button 68 of the concerned network and the network number (PN1) of the concerned network on the left side of the generated top row 61a.

In a step S3, the CPU executes a lower row display subroutine shown in FIG. 9. In a step S4 of FIG. 9, the CPU specifies a first device in the network displayed in a display row to be processed (current row) as a processing object. Here, in the lower row display subroutine started in the step S3 of FIG. 8, the display row of the processing object (current row) in the step S4 is the top row 61a. In addition, the device specified as the first processing object is a device at the top of the connection order (a device corresponding to the device image 62 at the left end in the concerned display row), for example.

In a step S5, the CPU determines whether the device specified as the processing object is the connection node (bridge) or not, based on the device list stored in the memory. When the device specified as the processing object is the connection node (YES in the step S5), the CPU determines in a step S6 whether the connection node is set as the full bridge or the partial bridge, based on the device list stored in the memory.

When the device specified as the processing object is the connection node (YES in the step S5) and set as the partial bridge (“Partial” in the step S6), in a step S9, the CPU additionally forms a new display row at the bottom of the display row already displayed in the network display area 60, displays the partial bridge image 67 in the formed display row based on the device list stored in the memory, and displays the connection cable image 66 connecting the device image 62 of the specified device with the partial bridge image 67. The CPU also displays the property display button 68 with respect to the concerned network and the network number (PNn) showing the concerned network on the left side of the display row additionally formed at that time. The network number (PNn) corresponds to the number n (where n is a positive integer) of the display row currently displayed in the network display area 60 including the display row additionally formed at that time.

When the specified device is the connection node (YES in the step S5) and set as the full bridge (“Full” in the step S6), in a step S8, the CPU additionally forms a new display row at the bottom of the display row already displayed in the network display area 60 of the audio network view screen, displays one or plural device images 62 configuring the network connected to the specified device (connection node) in the formed display row, based on the device list stored in the memory, in an arrangement of the horizontal direction in accordance with the connection order, and displays the connection cable image 66 connecting between the device images 62. The CPU also displays the property display button 68 with respect to the concerned network and the network number (PNn) showing the concerned network on the left side of the display row additionally formed at that time. In the step S9, the CPU executes the lower row display subroutine for the display row newly added in the step S8.

After the processing of the step S7 or S8 and S9 is executed for the specified device, or when the specified device is not the connection node (NO in the step S5), the CPU specifies, in a step S10, the next device (the device adjacent to the downstream side of the transmission frame with respect to the device currently specified as the processing object) as the processing object in accordance with the connection order of the device of the network in the current row. The CPU repeats the loop processing of the steps S5 through S11 until finishing specifying all devices connected to the network in the current row as the processing objects (YES in the step S11). After finishing the processing of the steps S5 through S11 to all devices connected to the network in the current row (NO in the step S11), the CPU finishes the audio network view screen display processing.

According to the step S2 of FIG. 8, in the top row 61a, the device image 62 showing the DSP_A (the node connected to the PC displaying the screen) at the top of the device list of the network 1 shown in FIG. 7 is displayed at the left end (upstream side), and subsequently, plural device images 62 are sequentially displayed at the immediate right side in accordance with recording order of the concerned device list. The connection cable image 66 is displayed between the terminals of the first N_I/O image 64 of the device image 62. Because the eighth row of the device list of the network 1 (below the row of IO2 at the rear end of the connection order) is the “loop”, the connection cable image 66 looping the devices is displayed between the device image 62 (IO2) at the right end and the device image 62 (DSP_A) at the left end in the drawing. The display of the loop reveals that the devices in the basic network are connected in a ring.

By executing the lower row display subroutine for the basic network in the top row 61a through the step S3, each time when the connection node is detected in the basic network through the processing of the steps S4 through S8, a new row is added one after another from the second row of the display row, and the configuration of the destination network of the detected connection node can be displayed in the newly added display row.

A search for the connection node in the basic network is executed from the top in sequence, and therefore, as shown in FIG. 6, the configuration of the network 50 connected to the basic network (network 1) through the CS2 set as the full bridge is displayed in the second display row 61b. In the display row 61b, the device image of the IO4 connected to the CS2 is displayed at a position aligned in the vertical direction of the CS2 image 62 in the third column from the left side of the top row 61a. The connection cable image 66 is displayed between the second N_I/O image 65 of the CS2 image 62 and the first N_I/O image 64 of the IO4 image 62.

As described above, for the other network connected to a certain network with the full bridge setting, the configuration and the connection status of the network are displayed with the connection node images 62 aligned in the vertical direction and the device image 62 connected thereto, and the device images 62 arranged in the horizontal direction in the display row showing the network. According to the display example of FIG. 6, the connection node shown with the hatching in the device list of FIG. 7 is not displayed in the display row of the network corresponding to the device list. In other words, the image 62 of the connection node is displayed only in the display row (upper display row of two networks connected through the concerned connection node) of the network connected through the first N_I/O of the device.

Furthermore, for the display row showing the other network connected to a certain network with the full bridge setting (for example, the network in the second display row 61b), the lower row display subroutine is executed in the step S9 on the precondition that the display row is the current row, and therefore, each time when the connection node is detected in the other network, a new row is added one after another, and the configuration of the destination network of the detected connection node can be displayed in the added display row.

Therefore, when the connection node set as the full bridge is detected, the display processing (step S8) of the new display row one after another and the network configuration are executed in each case, and the processing of executing the lower row display subroutine in the step S9 is repeated for the new display row. As a result, plural networks coupled to the basic network with the full bridge setting are displayed in consecutive display rows in order from the proximity of the basic network.

For example, in FIG. 6, the configuration of the network 50 connected to the basic network (network 1) through the CS2 with the full bridge setting is displayed in the second display row 61b, and furthermore, the network 52 connected through the IO4 in the network 50 with the full bridge setting is displayed in the third display row 61c.

In the third display row 61c, the IO6 image 62 and the IO5 image 62 configuring the network 52 are displayed in the arrangement of the horizontal direction. After the display processing of the third display row 61c, the CS1 of the network 1 is specified as the processing object (step S10), and the network 51 connected through the CS1 with the full bridge setting is displayed in the fourth display row 61d (step S8). At this time, the display position of the CS1 image 62 in the top row 61a and all device images 62 at the left side are shifted to the right side of the drawing. Accordingly, the displays relating to plural networks do not overlap with each other.

As shown in the fourth display row 61d, the connection cable image 66 is not displayed between the IO7 image 62 and the IO8 image 62, and it explicitly shows that the IO7 and the IO8 are not connected (see the connection example of FIG. 1), or in other words, the connection manner of the network 51 is the cascade. The end of the cascade network is explicitly shown, and therefore the user can recognize from the screen which part the user has to connect to make the loop.

For the connection nodes (IO1 and IO3) set as the partial bridge, in the step S7, the partial bridge image 67 is displayed at the position aligned in the vertical direction of the device image 62 of the connection node. Therefore, although the network configuration of the other system beyond the network for connection connected with the connection node is not displayed, the display of the connection cable image 66 coupling each terminal of the second N_I/O image 65 of the connection node image with the partial bridge image 67 shows that the other system is connected to the upstream terminal of the second N_I/O of the connection node and the other system is connected to the downstream terminal. For example, the second N_I/O image of the IO3 image 62 shows the connection cable image 66 only at the upstream terminal, and the other system is connected to the upstream side of the second N_I/O 35 of the IO3; however, it can be visually recognized that the other system is not connected to the downstream side.

In FIG. 6, the PC 110 connected to the DSP_A is intended to display the audio network view screen, and therefore the network 1 becomes the basic network displayed in the top row 61a, the DSP_A image 62 is displayed on the left side (beginning) of the top row 61a, and the devices connected to the same network are displayed in order from the DSP_A to the downstream side. Below the network, the other network connected to each connection node is displayed in order from the upstream connection node for one network in one row. The audio network view screen is displayed based on the device list which the device for displaying the screen has, an appearance of the audio network view screen (such as the basic network displayed in the top row 61a or the display position of the device images 62) changes according to the device for displaying the concerned screen. For example, in the case where the audio network view screen is displayed on the console CS1, it is the same that the network 1 is displayed in the top row 61a; however, the console CS1 image 62 is displayed on the left end of the top row, and the other devices in the network 1 and the other network connected to the network 1 are displayed with reference to the position of the console CS1 image 62. In the case of displaying at the PC 111 connected to the input/output device IO6, the network 52 connected with the IO6 is displayed in the top row 61a, the IO6 image 62 is displayed on the left side of the top row, and the other display is executed with reference to the position of the IO6 image 62.

### <<Update of Device List>>

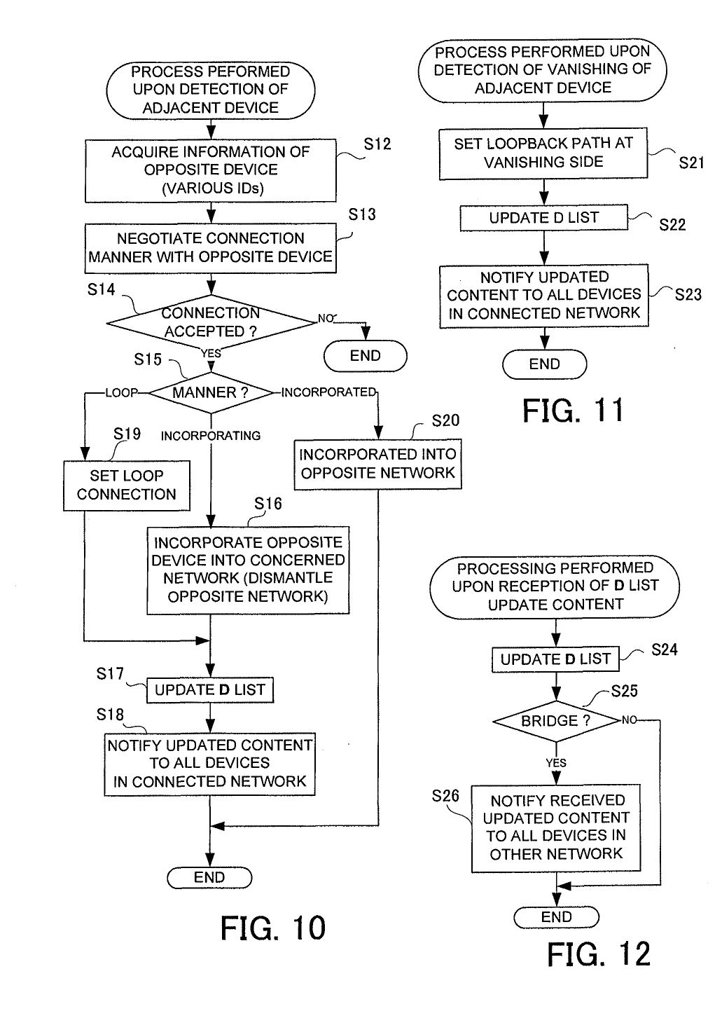

The device list for each network stored in the memory 11, 21 or 31 of each device is updated when the configuration of the network corresponding to the list is changed (when a new device is detected in the network, or when existing device in the network vanishes). As the operation of the audio network communication function (more specifically, MAC layer in a hierarchical model of the communication protocol of the audio network) responsible of the N_I/O (14, 15, 24, 25, 34 or 35) of each device, each device executes the processing shown in the flowchart of FIG. 10 when newly detecting the device adjacent to the device itself (the device connected to the N_I/O of the device itself). In addition, when each device detects the vanishing of the device adjacently connected to the device, each device executes the processing shown in the flowchart of FIG. 11.

### <<At the Time of Detecting Adjacent Device>>

When a new device is physically connected adjacent to a certain device and the power of the adjacent device is turned on (that is, when there is any response from the adjacent device to the concerned device), the certain device detects the new adjacent device. In other words, the certain device is physically and electrically connected to the opposite device, and the certain device can transmit and receive a frame in Ethernet (trademark) format with the opposite device.

When the new adjacent device is detected, in a step S12 of FIG. 10, the concerned device acquires the information (such as the model ID and the equipment ID) identifying the detected adjacent device (opposite device). In a step S13, the device negotiates with the opposite device about acceptance or rejection of the connection of the opposite device to the concerned network and the manner in the case of connection acceptance. When the connection rejection is determined due to the circumstance of any device (NO in a step S14), the processing is terminated without change. In this case, even if the concerned device and the opposite device are physically connected, the transmission path of the transmission frame including the opposite device is not formed. The situation is handled in the device list as a status in which the transmission path is not circulated and the audio signal is disconnected (open).

The connection manner in the case of the connection acceptance is any of the connection manner in which the opposite device is incorporated into the network of the concerned device (incorporating), the connection manner in which the concerned device is incorporated into the network of the opposite device (incorporated), or the connection manner in which the concerned device and the opposite device belong to the same network, two devices are connected to each other, and then the network change the connection manner from the cascade manner to the ring manner (loop). It should be noted that the incorporating/incorporated connection manner is completely different from the connection of two networks through the connection node (bridge).

As described above, each device is provided with the communication interface having at least a pair of the upstream and the downstream terminals, and the detection of the adjacent device means the situation where the connection of the other device is detected on the pair of the upstream terminal and the downstream terminal. When the device is provided with plural pairs of the upstream and the downstream terminals and the connection of the other device is detected on the other pair of the upstream and the downstream terminals different from one pair of the upstream and the downstream terminals, it is a situation where the concerned device operates as the connection node, and the processing in the situation will be described later.

The acceptance or the rejection of the connection and the connection manner are determined in the negotiation between the devices (between the networks) by exchanging the setting or the status of the network between the devices. For example:

i) In a case where the opposite device is not incorporated into any networks, the connection acceptance in the “incorporating” manner is determined in the concerned device.

ii) In a case where the opposite device has been already incorporated into the same network as the network of the concerned device and the connection manner of the ring transmission line changes from the cascade to the loop through the connection of the opposite device, the connection acceptance in the “loop” manner is determined in both devices.

iii) A case where the network incorporating either one of the devices is the network to be incorporated into the network of the other device. Specifically, (1) a case where originally same network has been divided, each network sets the loopback, and a negotiated network and the concerned network are formed, or (2) the incorporation acceptance into the negotiated network has been set to the concerned network in advance, or the like. In the above cases, the connection in the “incorporated” manner is determined in one device, and the connection acceptance in the “incorporating” manner is determined in the other device.

iv) In a case where the network incorporated with the opposite device is an unrelated network to the network of the concerned device, the connection rejection is determined in both devices.

In a case where the opposite device operates as the master node although the opposite device is one isolated device, the opposite device is considered as incorporated into one network, and the determination based on the rule iii) or iv) is made.

In addition, even if the rule i) or iii) is applicable, when the following conditions are also applicable, the connection rejection is determined

v) a case where, due to the incorporation of the opposite device into the network of the concerned device, the total distance of the network (or delay time of the frame transmission line) exceeds an allowable distance (or an allowable time length).

vi) a case where, due to the incorporation of the opposite device into the network of the concerned device, the number of the equipment connected to the concerned network exceeds an allowable number.

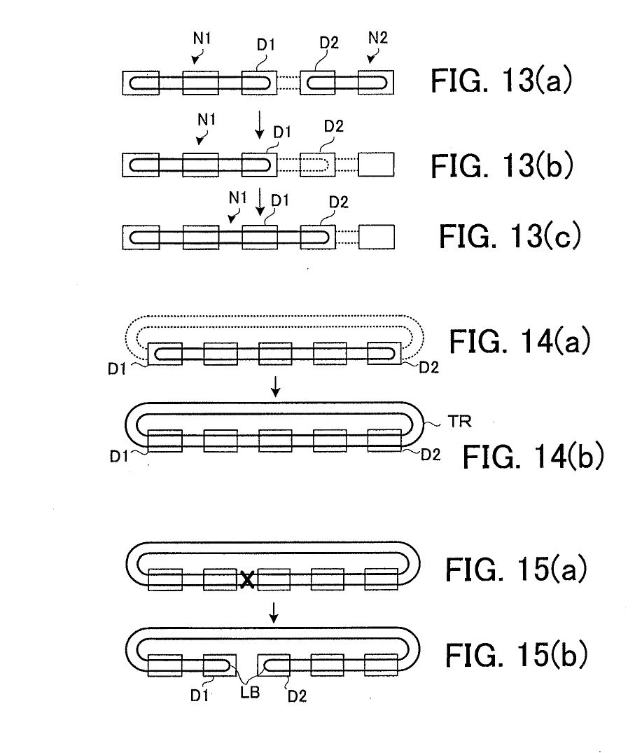

When the connection acceptance is determined (YES in a step S14) and the connection is in the incorporating manner (“incorporating” in a step S15), in a step S16, the processing of incorporating the opposite device into the network of the concerned device is executed. FIG. 13 is views that illustrate the change of the network configuration due to the incorporation of the opposite device. When a device D1 of a network N1 detects the connection of an adjacent opposite device D2 (state of (a)), a network N2 of the opposite device D2 is dismantled with a command from the device D1 (dismantlement of the opposite network N2 shown in (b)), and the opposite device D2 not belonging to any network is incorporated into the network N1 of the concerned device D1 (state of (c)).

In a step S17, the concerned device updates the contents of the device list of the network to which the concerned device belongs of the device lists stored in the memory of the concerned device based on the device identification information acquired in the step S12. Accordingly, a row for recording the currently detected opposite device (in a case of FIG. 13, the opposite device D2) is newly added to the device list, and the information of the opposite device is written in the added row. In a case of an example of FIG. 13, the device list held in each device of the network N1 is initially written in order of {D1, open, D*, D*} (“*” denotes “Don't Care”). The “open” in the last row denotes that the concerned network is formed in a cascade. When the device D2 is connected to the device D1 and the device D2 is incorporated into the network N1, the device list is updated in the device D1 to {D1, D2, open, D*, D*} in which the device D2 is added to the downstream side of the device D1. When an additional device D3 is incorporated, the device list is updated to {D1, D2, D3, open, D*, D*}.

In a step S18, the contents of the updated device list is notified to all devices connected to the concerned device. Accordingly, the notification is provided to all devices in the network to which the concerned device belongs and all devices in all networks connected to the network through the connection node (bridge). Each device receiving the notification updates the contents of the device list stored in the device through the processing of FIG. 12 described later. All connected networks also include the network connected with either of the full bridge and the partial bridge settings. The notification method may be, for example, of writing the update contents (update result) to the transmission frame and reading the update result from the transmission frame by each device, or specifying the device to be notified in order for each device and providing the notification to each device in order. The notification range of the update contents of the device list of each device may be a less number of the devices than the number of all connected devices. In accordance with the generated device list, for example, when the device list of all networks including the audio network system 100 is generated, the notification may be provided to all devices in the audio network system 100. In this case, if the connection node set as the partial bridge in the network system is configured to provide the notification on the information of the adjacent device in the connection network connected to the second N_I/O, then the control device can display the partial bridge image 67 in the network view screen based on the notified information. When the device lists of all networks included in the audio network system 100 and the adjacent network are generated, the update contents of the device list of each device may be notified to all devices in the networks.

Furthermore, when the connection acceptance is determined (YES in the step S14) and the connection is in the loop manner (“loop” in the step S15), in a step S19, the concerned device and the opposite device are looped. FIG. 14 is views that illustrate the change of the network configuration due to a loop. When both ends D1 and D2 of the cascade network are looped (state of (a)), the whole network is connected in a ring, and the ring transmission path TR including the loop of both the ends D1 and D2 is formed (state of (b)). When the connection cable capable of bi-directional communication is used, the ring transmission path is formed double.

The concerned device updates the contents of the device list of the network to which the concerned device belongs after the setting of the loop (step S17) and provides the notification of the contents of the updated device list to all devices connected to the concerned device (step S18). Each device receiving the notification updates the contents of the device list stored in the device through the processing of FIG. 12. By the update of each device list, the “loop” is written in the last row of the list as the information indicating the connection status.

When the connection acceptance is determined (YES in the step S14) and the connection is in the incorporated manner (“incorporated” in the step S15), the concerned device is incorporated into the network of the opposite device (step S20). That is, the opposite device issues a command to the concerned device to dismantle the network to which the concerned device belongs, incorporates the concerned device not belonging to any networks into the network of the opposite device (step S16), and provides the notification of the update of the device list and the update result (steps S17 and S18). As apparent from the above description, when there is only one device (node) in an early stage of the network configuration, the device list is in a state where only the concerned device is registered, and at each time when the device (node) is added to the network (when a new node is added to an existing node through the connection cable), the added node is added to the end of the device list, and the device list written in order in which each node finally configuring a daisy chain is physically connected. In the above description, the incorporating opposite device is determined to be a single device; however, the device may be incorporated in a unit of the network.

### <<At the Time of Vanishing of Adjacent Device>>

When the vanishing of the adjacently connected device is detected, in a step S21 of FIG. 11, the concerned device sets the loopback path (loopback (LB)) of the transmission frame to one of two terminals of the first N_I/O (the side of the upstream side and the downstream side of the audio network on which the vanishing of the adjacent device is detected). FIG. 15 is views that illustrate the change of the network configuration due to the vanishing of the adjacent device. When a part of the connection of the ring network is disconnected (state of (a)), the loopback path (LB) is formed in the respective devices D1 and D2 of a disconnection section, and the concerned network is then in the cascade connection manner in which the devices D1 and D2 are set as the ends (state of (b)).

In a step S22, the concerned device detecting the vanishing of the adjacent device updates the contents of the device list of the network to which the device belongs. By the update of the device list, the “open” is written in an upper or a lower row of the concerned device as the information indicating the connection status. The position of the row in which the “open” is written differs depending on circumstances in which the vanishing side is the upstream side or the downstream side of the audio network with reference to the concerned device. In a case where the network is originally the cascade network (in a case where the “open” has already been written in the list), all information of the device on the vanishing side in which the “open” is newly written up to the existing “open” is deleted from the device list. In a case where the network is originally the ring network (in a case where the “loop” is written in the list), the information of any device is not deleted from the device list, but only the symbol “loop” is deleted. For example, in a case of FIG. 15, the initial device list of the device D1 is {D1, D2, D*, D*, D*, loop}, and the device list is updated after the disconnection to {D1, open, D2, D*, D*, D*}. Furthermore, the initial device list of the device D2 is {D2, D*, D*, D*, D1, loop}, and the device list is updated after the disconnection to {D2, D*, D*, D*, D1, open}. In a step S23, the contents of the updated device list is notified to all devices connected to the concerned device. Each device receiving the notification updates the contents of the device list stored in the device through the processing of FIG. 12. The range provided with the notification is, as the same as that in the step S18, all devices in the network to which the concerned device belongs and all networks connected to the network through the connection node with the full bridge or the partial bridge setting. For example, in a case of FIG. 15, the information indicating the disconnection of the device D2 is notified to the other device as the device D1 set as the starting point, as well as the information indicating the disconnection of the device D1 is notified to the other device as the device D2 set as the starting point, and the device list of each device receiving the notification is updated.

The flowchart of FIG. 12 shows a processing example in which the device executes when the device list update notification through the step S18 or S23 is received. In a step S24, the CPU of the device updates the corresponding device list stored in the memory in the device in the same manner as the update executed for the notification source device in accordance with the received update contents. In a case where the device is the connection node (YES in a step S25), in a step S26, the device provides the received device list update notification to all devices in the destination network through the connection node. The connection node is a part that connects two networks, and therefore the destination network of the connection node means the other network with respect to the network that receives the update contents. The notification of the update contents is provided also to the destination network of the connection node, and therefore all devices in all networks connected with each other (whole the connection example shown in FIG. 1) can receive the update contents of the device list and update the stored device list.

As described above, at each time when the configuration of individual network is changed, the device list of the concerned network in which all devices have is updated. Therefore, the audio network view screen can always display the current connection manner of the audio network system 100.

Because the device list is updated and generated through the audio network communication function of each device (more specifically, MAC layer in a hierarchical model of the audio network communication protocol) and not merely recorded with the physically connected devices but recorded with the connection status of the devices in which the transmission path of the transmission frame is formed, the user can verify the connection status of the network corresponding to the path in which the transmission frame actually flows through the display of the network view screen in accordance with the device list. In addition, plural connected devices are listed on the device list of each network in the connection order, and which device is connected to the upstream side of each device and which device is connected to the downstream side can be verified through the display of the network view screen.

### <<Update of Device List: at the Time of Operation Disclosure as Connection Node>>

When any terminal of the second N_I/O of the device connected to the first network through the first N_I/O is connected to any terminal of any N_I/O of the other device not belonging to the first network, in a similar way to the step S13 described above, the concerned device negotiates with the opposite device for acceptance or rejection of the connection. When the negotiation succeeds, in a similar way to the step S15 through step S20, the transmission path of the transmission frame of the second network including at least the concerned device and the opposite device is formed, and the concerned device is set as the connection node (bridge) for connecting the first network and the second network. At the time when the transmission frame starts to circulate in both networks, the concerned device starts to bridge the data in the Ethernet (trademark) area 43. In other words, the frame data in the Ethernet (trademark) format written in the Ethernet (trademark) area in one network is written (routed) in the Ethernet (trademark) area of the transmission frame in the other network as needed in accordance with the address.

In the above situation, if the concerned device operates as the master node in one of the first network and the second network, the transmission periods of the transmission frame in the first network and the second network, that is, the sampling clocks of the audio signal are in synchronization with each other, and the conditions in which the audio signal of one network is flown into the other network are met, and therefore the concerned device starts the bridge operation of the audio signal according to the bridge setting. In other words, when the bridge setting of the concerned device is set to the full bridge mode, the audio signals of all N transmission channels written in the transmission frame in one network are written in the same N transmission channels of the transmission frame in the other network, and when the bridge setting is set to the partial bridge mode, the audio signal of the N transmission channel set to be transferred among the audio signals of the N transmission channels written in the transmission frame in one network is written in the N transmission channel assigned to the concerned device in the other network.

When routing of the frame data in the Ethernet (trademark) format starts, the update of the device list executed in any device in one network is notified to each device in the other network over the concerned device, and the device lists of all devices in two networks are updated with the notification. The procedure of the device list update in this case is fundamentally the same as that in a case of single network. The concerned device first provides the notification of the information of the device list of the first network in the possession of itself to the adjacent device in the second network and receives the information of the device list of the second network from the adjacent device in the second network. Based on the received information of the second network, the concerned device generates the device list of the second network including the equipment ID of itself and the equipment ID of each device in the second network included in the information and provides the notification of the information of the generated device list to each device in the first network.

In a case where the negotiation in the step S13 fails (connection rejection) when new connection at the second N_I/O is detected, the second N_I/O is equivalently considered as no connection, and a new device list is not generated for the connection.

As described above, by displaying the audio network view screen according to the present embodiment, the user can recognize the number of the devices and type of the device configuring each network and the connection order of plural devices configuring each network about the connection manner of the system 100 including plural networks from the screen. In addition, the user can recognize the connection manner of each network (cascade or ring) from the audio network view screen, and in the case of the cascade, the user can easily recognize which two devices should be looped. The user can also recognize whether two networks connected through the connection node are connected with the full bridge setting or the partial bridge setting from the audio network view screen. Furthermore, in the case of the full bridge setting, because the network configuration is displayed, the user can easily recognize the device configuration of all range remotely controllable with the control device as one system 100 from the audio network view screen.

In the audio network view screen of FIG. 6, the configuration that displays the network to which the device for displaying the screen belongs as the basic network in the top row 61a (configuration in which the basic network changes in response to the device for displaying the screen) is described; however, one network in the system 100 may be fixed as the basic network. That is, one of the device lists for each network possessed by each device may be fixed as the device list for the basic network.

The configuration such that display order (display of connection order) of each device image 62 in each display rows 61a through 61f on the audio network view screen of FIG. 6 changes in response to the device for displaying the screen is described; however, the configuration may be such that the display order (display of connection order) of each device image 62 in each network is fixed. That is, recording order of the devices in the device list for each network possessed by each device may be fixed to the order in common with all devices.

In the above description, the image 62 of the connection node is configured to be displayed in the display row (upper row of the display rows displaying two networks) of the network connected through the first N_I/O of the device; however, the image 62 of the connection node may be displayed in the display row (lower row of the display rows displaying two networks) of the network connected through the second N_I/O of the device. In addition, the image 62 of the connection node may be displayed in both display rows of two networks.

Not all devices require having two N_I/Os, but at least the device set as the connection node may have two N_I/Os. It is sufficient that at least one connection node may exist in the network in the case where plural networks are connected with the full bridge or the partial bridge.

Another network connected with the partial bridge does not necessarily require detecting the connection order of the device and generating the device table.

Two signal processing engines (DSP_A and DSP_B) according to the present embodiments are configured to execute a mirroring operation for redundancy; however, the engines may independently execute different signal processing and therefore may expand the scale of the mixing processing.

In the above descriptions, each node is configured to have one or two interfaces for connecting one or two audio networks; however, the node may have three or more interfaces.

In the above descriptions, the interface of each node is configured to have a pair of (two) terminals with directional properties for connecting to the audio network; however, the interface may have three or more terminals.

In the above descriptions, the bridge setting means sets the parameter of two N_I/Os of the connection node stored in each current memory of the control device and the connection node in response to the setting operation. In addition, the operation of the bridge setting means may be performed such that the CPU of the individual connection node (bridge) controls the setting of itself in response to the command by the user, or the bridge setting in each connection node may be remotely controlled by the control device or the master node.

In the above descriptions, the audio network view screen is described in the manner in which the basic network is displayed in the top row and the other networks are sequentially displayed in a lower direction of the screen; however, various display manners may be adopted such as displaying from left to right direction, from right to left direction, from bottom to top direction, from center to outer peripheral direction in the display screen. Or, a virtually deep space approximately orthogonal to the display screen may be defined, and each hierarchy is displayed three-dimensionally in an arbitrary direction such as a depth direction or a forward direction. In this case, a display device capable of three-dimensional display such as a stereo liquid crystal display may be adopted as the display screen, and the three-dimensional display with naked eyes, shutter glasses, or the like may be performed. Or, the display screen may be displayed in a state where the network in each layer arranged three-dimensionally is projected onto a plane such that plural networks are super imposed to be displayed by means of providing one or plural display layers and drawing individual network for each layer In this case, it is preferable that the display order can be changed for each layer or network, drawing color schemes or brightness of drawing colors are changed, or the size of the drawn lines or characters is varied. In addition, the display manners may be combined appropriately.

What is claimed is:

1. An audio network system comprising at least one network including one or more devices coupled with each other via a cable in a form of a cascade network or a ring network and a control device connected to one of the devices or provided in one of the devices, wherein
each of the devices has at least one network interface provided with a first terminal and a second terminal, said cascade network is formed by coupling with a cable between the second terminal of the network interface of a first device and the first terminal of the network interface of a second device, coupling with a cable between the second terminal of the network interface of the second device and the first terminal of the network interface of a third device, and repeating such coupling in order, and said ring network is formed by coupling with a cable between the second terminal of the network interface of an end device of the cascade network and the first terminal of the network interface of a top device in the cascade network, and
wherein the audio network system further comprises:
a path forming section adapted to form a ring transmission path circulating through a plurality of devices coupled with each other in the form of the cascade or ring network;
a specifying section adapted to specify one of the devices as a master node so that the device specified as the master node generates a transmission frame at every predetermined period to transmit the generated transmission frame to the ring transmission path, and the transmission frame containing a plurality of audio signals and control data circulates through the plurality of devices along the ring transmission path;
an audio signal path control section adapted to specify one device as a source and another device as a destination so that the device specified as the source writes an audio signal into the transmission frame while the transmission frame passes through the device, and the device specified as the destination reads the audio signal from the transmission frame while the transmission frame passes through the device; and
a control section adapted to transmit control data from the control device to the respective devices through the circulating transmission frame and controls the devices in accordance with the control data,
wherein the path forming section is further adapted use an end device of the plurality of devices coupled with each other in the form of the cascade network and having formed the ring transmission path therein to negotiate with an additional device newly connected to the cascade network in the form of a cascade or a ring with a cable and incorporate the additional device into the ring transmission path if a response from the additional device is affirmative, and
wherein the audio network system further comprises:
a first detecting section adapted to detect the plurality of devices existing in the ring transmission path formed in one network of the at least one network and a coupling order of the detected devices coupled in sequence via the cable; and
a display section adapted to graphically display images of the detected devices in the ring transmission path formed in the one network along with cable images indicative of coupling between the images of the detected devices in accordance with the detected coupling order on a display of the control device.

2. The audio network system according to claim 1, wherein the detected devices are not all devices but a part of the devices coupled with the cable in the cascade network or the ring network.

3. The audio network system according to claim 2, wherein at least one of the devices coupled with each other via the cable does not agree to be incorporated into the ring transmission path in the negotiation, and therefore the at least one of the device is not detected as a device existing in the ring transmission path by the first detecting section.

4. The audio network system according to claim 2, wherein a plurality of the devices are coupled with each other via cables in the form of the ring network, and the ring transmission path is formed in a plurality of devices coupled via cables in the form of the cascade network which are parts of the plurality of devices coupled with each other via cables in the form of the ring network.

5. The audio network system according to claim 1, wherein:
at least one of devices in the ring transmission path formed in a first network of the at least one network is a bridge device which has another network interface connected to a second network of the at least one network in the audio network system so that the second network is coupled to the first network via the bridge device;
the second network includes one or more devices coupled with each other via a cable in a form of a cascade network or a ring network, another ring transmission path is formed through a plurality of devices included in the second network, one of the plurality of devices operates as a master node generating a transmission frame at every predetermined period to transmit the generated transmission frame to the ring transmission path, the transmission frame for carrying a plurality of audio signals and control data circulates between the plurality of devices along the ring transmission path, a certain device among of the plurality of devices writes an audio signal into the transmission frame while the transmission frame passes through the certain device, and another device reads the audio signal from the transmission frame while the transmission frame passes through the other device; and
the bridge device is adapted to read the audio signals and the control data from the transmission frame of either one of the first and second networks and write the audio signals and the control data into the transmission frame of another one of the first and second networks, and the control section is adapted to remotely control the respective devices in the ring transmission paths in accordance with the control data transmitted to the respective devices through the transmission frame, and
wherein the audio network system further comprises:
a second detecting section adapted to detect the plurality devices existing in the ring transmission path formed in the second network and a coupling order of the detected devices coupled in sequence via the cable, and
wherein said images of the detected devices displayed by the display section are first images of the devices in the first network detected by the first detection section, and the display section is further adapted to graphically display, on the display of the control device, second images of the devices, detected by the second detection section, in the ring transmission path formed in the second network along with cable images indicative of coupling between the second images of the devices in accordance with the coupling order detected by the second detection section and one or two cables images indicative of coupling between the second images and an image of the bridge device in the first images.

6. The audio network system according to claim 1, wherein
a coupling between two devices via the cable has a directional property in one direction, the first terminal of one device is coupled to the second terminal of the device adjacent to an upstream side of the one device, and the second terminal of the one device is coupled to the first terminal of the device adjacent to a downstream side of the one device, and
the display section displays the respective cable images along with the directional property.

7. The audio network system according to claim 5, wherein the display section displays the first images of the detected devices in the ring transmission path formed in the first network in a first area on the display and the second images of the detected devices in the ring transmission path formed in the second network in a second area on the display.

8. The audio network system according to claim 7, wherein either of the first area and the second area extends in a horizontal direction on the display.

9. The audio network system according to claim 5, wherein
the bridge device is adapted to be operable in either a full bridge mode in which the second network is coupled to the first network as an expansion of the first network or a partial bridge mode in which the second network and the first network are coupled with each other as independent networks respectively,
the display section displays, in a case where the bridge device operates in the full bridge mode, the second images of the detected devices in the ring transmission path formed in the second network, and in a case where the bridge device operates in the partial bridge mode, an image for a partial bridge instead of the second images of the detected devices in the ring transmission path formed in the second network.

10. The audio network system according to claim 9, wherein the second detecting section detects the plurality devices existing in the ring transmission path formed in the second network and the coupling order of the detected devices only in the case where the bridge device operates in the full bridge mode.

11. The audio network system according to claim 1, wherein:
the first detecting section detects the plurality of devices existing in the ring transmission path formed in the one network and the coupling order of the detected devices by cooperation with the plurality of devices in the ring transmission path formed in of the one network; and
the cooperation with the plurality of devices comprises:
a preparing procedure of preparing a device list in one of the plurality of devices;
a detecting procedure of detecting, by each of the plurality of devices, information of a device adjacent to the device or information of a position of the device in the ring transmission path formed in the one network;
a notifying procedure of notifying, from each of the plurality of devices, the detected information to the one of the plurality of devices; and
a write procedure of writing, in the one of the plurality of devices, information about the plurality of devices existing in the ring transmission path formed in the one network into the prepared device list in an order corresponding to the coupling order in which the plurality of devices are coupled in sequence via the cable in accordance with the detected information notified from each of the plurality of devices.
